(19) United States
(12) Patent Application Publication
(10) Pub. No.: US 2022/0058932 A1
(43) Pub. Date: Feb. 24, 2022

(54) MAN OVER BOARD DETECTION SYSTEM

(71) Applicants: SOS Ltd., George Hill (AI); G.M.S. Global Maritime Services Ltd., London (GB)

(72) Inventors: Jens HJELMSTAD, Lillestrom (NO); Sverre DOKKEN, Monaco (MC); Alexis MICHAEL, Limassol (CY); Reiclulf MAALEN, Las Vegas, NV (US)

(21) Appl. No.: 17/415,538

(22) PCT Filed: Dec. 16, 2019
(86) PCT No.: PCT/EP2019/085419

§ 371 Date: Jun. 17, 2021

(30) Foreign Application Priority Data
Dec. 17, 2018 (EP) 18212924.7

(51) Int. Cl. G08B 21/08; G08B 25/00; G08B 29/18; B63C 9/00; G08G 3/02

(52) U.S. Cl. CPC G08B 21/08; G08B 25/008; G08G 3/02; B63C 9/0005; G08B 29/188

(57) ABSTRACT

A Man Over Board (MOB) system includes sensor units located around a periphery of a vessel, an interconnector unit communicatively coupled with the plurality of sensor units and configured to receive data from the sensors, a data fusion processing unit, and a control station. The data fusion processing unit is configured to receive the data from the sensor units via the interconnector unit, compile the data from the sensor units, and trigger a MOB warning based on the compiled data. The control station is located at a bridge of the vessel and configured to display the MOB warning and at least a portion of the compiled data from the sensor units via a video verification interface and receive verification input from a human operator via the video verification interface to confirm a MOB event.

### CROSS-REFERENCE TO RELATED APPLICATIONS

The present application is the U.S. national stage entry under 35 U.S.C. § 371 of international patent application PCT/EP2019/085419, filed Dec. 16, 2019, entitled “MAN OVER BOARD DETECTION SYSTEM,” and claims the benefit of European Patent Application No. 18212924.7, filed Dec. 17, 2018, entitled “MAN OVER BOARD DETECTION SYSTEM.” Each of these applications is incorporated herein by reference.

### FIELD OF THE DISLCOSURE

The present disclosure relates to a Man Over Board (MOB) detection system that can be integrated in an instrument room near a vessel's bridge to detect humans going overboard.

### BACKGROUND

MOB systems detect when humans go overboard a vessel. A need exists for improved MOB detection systems.

### SUMMARY

In an aspect, the present disclosure provides an apparatus or system forming a Man Over Board (MOB) detection system that comprises one or more sensor units around the periphery of the vessel with the option for embedded local software for first stage object detection and situation awareness (102A-102F), a control station with optional display unit with visual alarm capabilities (107) located at the vessel's bridge, fibre optical or ethernet cabling or wireless, also local power supply as part of the communications cables, connecting the sensor units and control station (103), an interconnector unit (104) and an e.g. integrated data fusion processing unit (105), that can be located in the vessel's instrument room and an implemented video verification software and central data fusion software, e.g. including the MOB detection software (106), within data fusion processing unit, but also integrated software for administrative functions and Human Machine Interface (HMI) software (108) within the control station.

In an example, the apparatus or system is capable of initiating a MOB event warning based on the data received from the sensor units and fused at the processing unit of the system. The warning is initiated through the system's configuration on the basis of the laser scanner alarm and/or radar alarm (sensors) and augmented with video pre-processing data. It is automatic since it does not require a human interaction to trigger the MOB event warning.

In an example, following the MOB event warning, the apparatus or system can generate a visual alarm which is located in the control station and may require acknowledgement by the authorised user, otherwise it remains active. The visual alarm is e.g.

built in accordance to the IMO Resolution A.1021(26).

In an example, an audible alarm can be triggered when a MOB event warning has been initiated, which also remains active until the authorised user acknowledges it in the control station. The audible alarm is e.g. located on the navigation bridge and contains an A-weighted noise level between 75 dB(A) and 85 dB(A) at distance of one meter from the system. The noise level is adjustable to at least 10 dB(A) above the ambient noise level but the upper noise level does not exceed 85 dB(A). Other alarms are installed in other locations of the vessel in accordance to the IMO Resolution A.1021(26).

In an example, the apparatus or system can make use of sensor units around ship periphery, fibre optical and ethernet cabling with the option of wireless connectivity the sensor units and control station, also with the option of using local power supply to the sensor units.

In an example, the processing is distributed on sensor units and on control station with the option of all sensor processing on sensor station or all on control station, or a combination of them, and then processed though the interconnector unit and the integrated data fusion processing unit, that are located in the vessel's instrument room. There is therefore the option for embedded local software for first stage object detection and situation awareness in the sensor units themselves.

In an example, within the integrated data fusion processing unit there is an integrated verification video software and central data fusion software including MOB detection software.

Under the normal operating conditions of the MOB system, and due to the processing of data from the sensor units as explained above and the prevailing manmade and natural sources of noise, the MOB system may give, on an average, less than 1 false alarm (i.e. not a genuine man overboard scenario) per day averaged over 90 days, but never more than 4 in a single day. This is enabled by the sensor selection and processing system, specifically using the (preferably multibeam) laser scanner unit (202) and augmented by (two or more) networked radar units (203) which is supported by video pre-analysis through the one (or more) video camera units (204). It is capable of recording and have an auto-diagnosis of alarms which implements also use of self-learning AI methods for further development.

In an example, the MOB detection zone of the sensor units is located at or below the lowest accessible open area and includes detection sensors that allow for a MOB event detection, covering all the periphery, ranges (using laser scanner unit and/or radar units) of the vessel for a minimum of 5 metres from the periphery of the ship. Additionally, the video units implemented in the system have the capability of coverage the periphery, all angles coverage of the ship, with the video data being of high resolution and capable of video stitching and target tracking.

In an example, the apparatus or system is capable of detecting any person within its MOB detection zone around the periphery of the ship using its sensor units.

In an example, the apparatus or system does not require any additional equipment (i.e. wear or carry anything) by the person in order to be detected and initiate a MOB alarm.

In an example, the apparatus or system can detect any person with a height of at least 1,467 metres, due to the general setup of the sensor units being sensitised to objects located outside the ship's hull and given plan, with given size and falling with acceleration equal to gravity. The detection using a laser scanner unit allows for a high update rate, capable of detecting all objects due to the multibeam laser scanner unit being sensitive to the given size, and with the capability of using multibeam or single beam time measurement it also allows for sensitivity to objects in free fall and additionally the usage of range and doppler radar for additional verification and control.

In an example, the probability of detection of a human or a testing manikin, during nominal operating conditions, passing through the MOB detection zone is be equal or greater than 95%.

In an example, the apparatus or system is able to process the fused data from the sensor units which can then alert for a MOB event, which can then be confirmed by an authorised system user, which in turn, generates a message in National Marine Electronics Association (NMEA) format from the NMEA interface from the processing system.

In an example, within the control station, there is implemented administrative software that embeds the with a date and time stamps and utilize the time code input from a valid coordinated universal time (UTC) feed to generate the date and time stamp.

In an example, the apparatus or system remains fully operational with the implemented standby mode. If it is advantageous for maintenance purposes, or permitted by responsible national or local authorities, it can be turned off. The system also allows for specific units or sections of the system to be partially deactivated by an authorised user for maintenance purposes.

In an example, the apparatus or system is able to automatically revert back to its normal operating conditions when the vessel is underway.

In an example, in the case that there is a system event, the user that initiated the event, the type of the event as well as the associated date and time are recorded.

In an example, for the purposes of exporting data, a description sufficient enough to the describe the data exported is also recorded.

In an example, in the event that there is a software upgrade, the new version is also be recorded. In the case that there is a change in the system settings, both the old and the new settings are recorded.

In an example, the apparatus or system is also enabled to automatically adjust the detection settings at a frequency greater than once an hour, therefore a lookup table or report that describes how the setting are applied may be supplied in lieu of the detection settings change event log entries.

In an example, the apparatus or system stores the system data, e.g. the required system data for a minimum of 30 days. The system stores the data in a resilient and redundant device such as a redundant array of independent disks (RAID) 6 array.

In an example, the apparatus or system allows an advanced user to set a data retention policy for the system. Once the data exceeds the data retention policy duration then it will automatically be destroyed. The data retention policy does not conflict with the 30-day minimum storage capability.

In an example, the apparatus or system is additionally fitted with an interface that is compatible with a voyage data recorder (VDR) or simplified VDRs (S-VDR). These would continue to operate even if there is a malfunction in the overall MOB system. The MOB alarm is recorded in a format that complies with the international digital interface standards set forth by IEC 61162-3:2014, and it can be recorded on the VDR or S-VDR as long as any recording or storage requirements of the said data is not compromised.

In an example, within the control station, there is implemented administrative software where the system records all the required system data while it is in an active state, including the operational status of the detection system and each sensor unit, the data captured from each sensor unit, any active MOB alarm logs, MOB log entries and a security log.

In an example, the security log software of the system includes records of log-ons and log-offs of the users, data export events and any software upgrades or system setting changes when those have taken place.

In an example, the implemented administrative software within the control station is also able to have multiple user accounts with different capabilities according to what has been authorised. For example, a potential master user is able to also control other types of user accounts and account information, but also create or delete any other user accounts.

In an example, other user accounts that might merely just have access to the system should not have the ability to alter or delete any recorded data, but the system is still recording any log user actions.

In an example, the power station of the system makes use of local or central power sources, and it is be capable of being powered from a 100 Vac to 230 Vac power source, or from a 24 Vdc power source. It can additionally make use for power purposes the 24 v step up to 48 v Power over Ethernet (PoE), local power storage for backup and use of energy harvesting solar or wind power.

The system has been tested and the designed components are in compliance to IEC 60945:2002(E), hence meeting the standard requirements for electromagnetic emission and immunity to electromagnetic environments.

In addition, all the components of the system can be compatible with the ingress protection rating of IP66 and also IP67 for all sensor units and cabling with testing performed at an accredited laboratory.

In an example, the apparatus or system has also been designed and tested to be capable of withstanding typical environmental vibrations that may be encountered and has been tested in accordance with IEC 60068-2-6:2007. Additionally, the selection of sensor units used are not sensitive to the typical environmental vibration.

In an example, the communication cables (fibre optical or ethernet cabling) which can also transmit power are manufactured with a choice of cables which are compliant with international standards and/or Regulations (for example the Restriction of the Use of Certain Hazardous Substances (RoHS) in Electrical and Electronic Equipment Directive (2011/65/EU) and the IEC 60092-376:2003 for low smoke and zero halogen, or equivalents). There is also an option to use local power supply and/or wireless communication to avoid use of the cables.

In an example, the apparatus or system and its components is installed in the navigating bridge or the chartrooms, have a maximum A-weighted noise level of less than 65 db(A), in accordance with the IMO Resolution MSC.337(91). Other system components located elsewhere in the ship have maximum A-weighted noise levels follow the noise levels set out in the IMO Resolution MSC.337(91). The audible alarm is be exempted from such requirements.

It should be noted that A-weighted noise level is measured by a sound meter in which the frequency response is weighted according to the A-weighting curve defined in IEC 61672:2013.

In an example, the acknowledgement of a MOB warning is performed by the authorised user at the control station of the system, where the user can acknowledge, deny, or confirm the MOB event alarm.

In an example, access to the control station is only available to authorised users with the appropriate credentials, in accordance with the implemented administrative software.

In an example, within the control station, the system contains an electronics unit, which will push the MOB alarms and make available the MOB verification data, in in the form of still or video images, to the user of the system within 5 seconds of the MOB event warning and would allow for playback of the available MOB verification data. These can include data obtained from the sensor unit that initiated the MOB warning and also data 5 seconds before and 5 seconds after the MOB event warning.

In an example, these or the MOB verification data have a resolution that allows for the authorised user to distinguish a person and other objects at the maximum range of the MOB detection zone of the system, which is achieved by the high sensitivity and low latency in processing using local or central processing and a detailed functionality as outlined for central processing and alarm.

In an example, one or each sensor unit's capture data is recorded in its final data format and the video data from a MOB event alarm are captured in the native resolution and frame of the camera used.

In an example, within the control station there is the capability that different alarms and data can be reviewed, and the authorised user has the capability to select a sensor unit and a timeline for playback at the control station.

In an example, within the control station, the authorised user can also monitor the operational status of the detection system, which is displayed at power up, reset, or if a change occurs to the system status. The operational status displays the activation state (active or inactive) of the system's sensor units and the functional state (normal or malfunctional) of the system sensor units.

In an example, within the control station the light intensity of the light emitting system components is being controlled using a choice of hardware controllable light output or software light settings or a night mode HMI display. The light emitting system components located or installed in the bridge is fully dimmable and controlled in the control station.

In an example, from the control station, the authorised user can also manually initiate an immediate MOB warning for drill purposes and recorded as such in the system, or for a manual review of data or video imagery of a MOB event that did not cause an alarm.

In an example, the testing method for the system involves two stages, a single sensor laboratory test that proves the probability of detection, and then a full system installation on a sea going ship that proves probability of detection and false alarm rate over a minimum of 90 days of testing.

Both tests are performed in controlled environment settings (whether indoors or outdoors), and the environmental conditions are within the range of environmental conditions as set out in the test plan, including temperature, wind, light intensity (both general and measured at the sensor units), visibility, cloudiness, rain and fog.

In an example, the probability of detection is calculated by conducting at least 100 drop tests with the testing manikin throughout the detection envelope of the sensor. To ensure adequate testing coverage, the detection envelope is divided into 20 test regions of approximately equal areas. Five drop tests are conducted at each region, of these five drop tests, two are be conducted 1 metre to 3 metres above the sensor plane, one is conducted 4 metres to 6 metres above the sensor plane, and two are conducted 7 metres to 10 metres above the sensor plane. The tester is performing the tests at different locations within each defined area, including the bow and stern.

In an example, the shipboard testing is performed on a vessel that is authorized to carry at least 250 passengers, has onboard sleeping facilities for each passenger, and is not engaged on a coastwise voyage. Shipboard testing is performed on the fully installed MOB detection system over a period of 90 days.

In an example, the apparatus or system while undergoing testing is still enabled to collect and record in the test logs the following information for a complete overview of the testing: test dates and times, the testing organization or accredited laboratory, the name of the tester, the test location and whether it was indoors or outdoors, the light intensity (including both the general but also the maximum intensity measured at surface of the sensor), the system manufacturer, the system details (i.e. sensor types, number of sensors during tests, model, serial numbers of sensors used, etc.), map of sensor detection envelope and associated test regions, environmental conditions, model of manikin used during the drop tests (including its serial number) and also any modification to the said manikin for test (e.g. clothes, equipment, heated sections, etc.), drop height (with respect to the sensor plane) and possible deck activities such as washing, painting, life boat operations, etc.

In an example, the testing manikin used has at least a mass of 40 kg and a height of at least 1,467 m with basic human shape (two arms, two legs, a torso and a head) in order to make sure that the system responds accordingly in a man overboard event.

Additionally, during the testing periods, the test logs also include ship information, such as the ship name, its location, ship heading, speed, roll, heave but also detailed weather and metocean conditions such as wave height, air temperature, water temperature, wind speed, weather conditions and precipitation amongst others.

Additionally, during non-nominal operating conditions, the probability of detection is to be recorded when safe and practical for informational purposes.

In an example, for the purposes of exporting data, a description sufficient enough to the describe the data exported is also recorded.

In an example, in the event that there is a software upgrade, the new version is also be recorded. In the case that there is a change in the system settings, both the old and the new settings are recorded.

### BRIEF DESCRIPTION OF THE DRAWINGS

FIG. 1 shows a block diagram representation of an illustrative MOB detection system in accordance with the principles of the present disclosure.

FIG. 2 shows a block diagram representation of an illustrative control station for a MOB detection system in accordance with the principles of the present disclosure.

FIG. 3 shows a block diagram representation of interconnected sensor units in a MOB detection system in accordance with the principles of the present disclosure.

### DETAILED DESCRIPTION

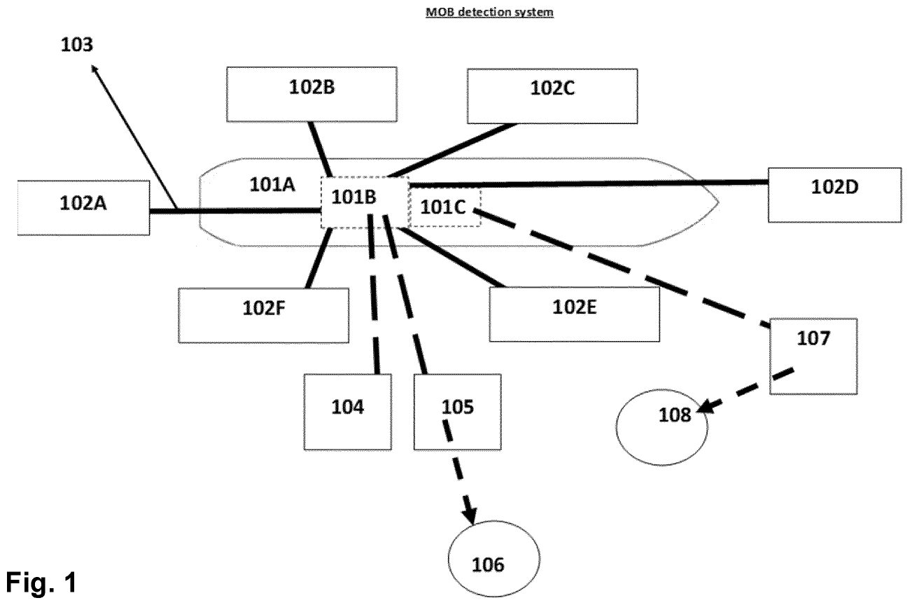

FIG. 1 shows a block diagram representation of an illustrative MOB detection system in accordance with the principles of the present disclosure.

The example shown in FIG. 1 represents the general physical configuration of the Man Over Board detection system. The overall shape represents the vessel 101A, while the dotted-line squares represent parts of the vessel 101A. The regular boxes in the drawing represent physical units. The straight lines represent physical cables, while the dashed lines represent the location of the physical units within the different parts of the vessel. The circles represent the integrated software, whereas the dashed arrows show to which physical unit the software is integrated to. Lastly, the straight-line arrow indicates the cables used for the Man Over Board detection system.

An instrument room of the vessel 101A may be near a bridge 101C of the vessel 101A. 102A-102F represent the general configuration of the sensor units 102 that cover the periphery of the vessel, and any sensor unit 102 can be a multibeam laser scanner unit, networked radar unit or a video camera unit, allowing adjustability in the configuration as long as the periphery is covered. Each sensor unit 102 also contains the option for embedded local software for first stage object detection and situation awareness. The sensor units 102 are connected through fibre optical or ethernet cabling (with the option also for wireless connectivity) 103 between the sensor units 102 and the vessel 101A, but also acts as local power supply that is integrated as part of the communications cables between the sensor units and control station located at the vessel's bridge 101C. The sensors units 102 are all connected into an interconnector unit 104 (104) which is located at the vessel's instrument room 101B. The data that are transferred are processed in the data fusion processing unit 105 located at the vessel's instrument room 101B. Within the data fusion processing unit there is integrated a video verification software and central data fusion software including MOB detection software 106. The control station 107 of an alarm system with a display unit and visual alarm capabilities is located at the vessel's bridge 101C, and has an integrated software for administrative functions and Human Machine Interface (HMI) software 108.

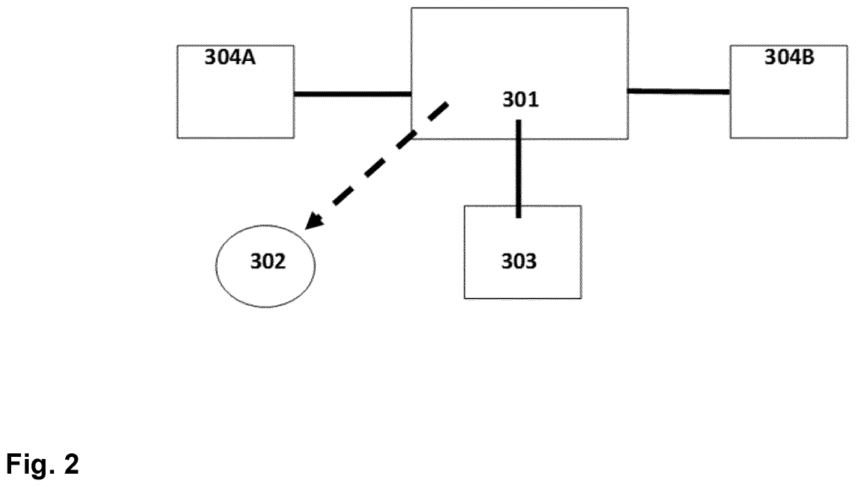

FIG. 2 shows a block diagram representation of an illustrative control station for a MOB detection system in accordance with the principles of the present disclosure. A control station 301 with display may be located at the vessel's bridge and allows authorised system users to acknowledge, deny, or confirm a MOB warning or alarm at the control station. The resolution of the MOB verification data in still or video images may be sufficient to allow for a human operator to distinguish between some human and other objects at the maximum range of the MOB detection system.

The system monitors the operational status of the system and displays the activation state (active or inactive) of all system sensors and the functional state (normal or malfunction) of all system sensors at power up, reset, or change of system status. Access to the control station 301 may be restricted to users with the appropriate credentials.

The system has the capacity to store the required system data for a minimum of 30 days. It is possible for an advanced user to set a data retention policy for the system and once data exceeds the data retention policy duration then it may be automatically destroyed. The data retention policy does not conflict with the 30-day minimum storage capability.

Software 302 implemented within the control station 301 has MOB administrative functions, including different types of user accounts on the system, record all the required system data while the system is in an active state (operational status of the system; operational status of each sensor unit; data captured from each sensor unit ; any active MOB alarm logs; MOB log entries; and security log), testing information log and for each system event: the user that initiated the event, the type of the event, and the date and time associated with the event may be recorded.

In the case of a data export event, a description sufficient to describe the data that was exported from the system is also being recorded.

In the case of a software upgrade event, the new software version is also being recorded.

In the case of a system setting change event, both the old and new settings will be recorded. If the system automatically adjusts the detection settings at a frequency greater than once an hour, a lookup table or report that describes how the settings are applied can be supplied in lieu of the detection setting change event log entries.

A data interface unit 303 may push the MOB alarms and make available the MOB verification data, in the form of still or video images, to a human operator within five seconds of a MOB warning and allow a human operator to control the playback of available MOB verification data. The system may have the capability for an operator to manually select an imaging sensor and timeline for playback at the control station. The electronics unit is connected via cable or wireless means to the sensor units.

A light emitting alarm function 304A and an audible alarm function 304B of the MOB detection system may be controlled by the control station. The intensity of light emitting system components of the light emitting alarm function 304A located or installed in the bridge area is fully dimmable and capable of being controlled at the control station, while the audible alarm function 304B remains active until the alarm has been deactivated or silenced at the control station unit.

The drawing represents the control station of the Man Over Board detection system in more detail. The boxes in the drawing represent physical units, while the circles represent the integrated software. The straight lines represent physical cables, while the dashed arrow line represents to which physical unit the software is integrated upon.

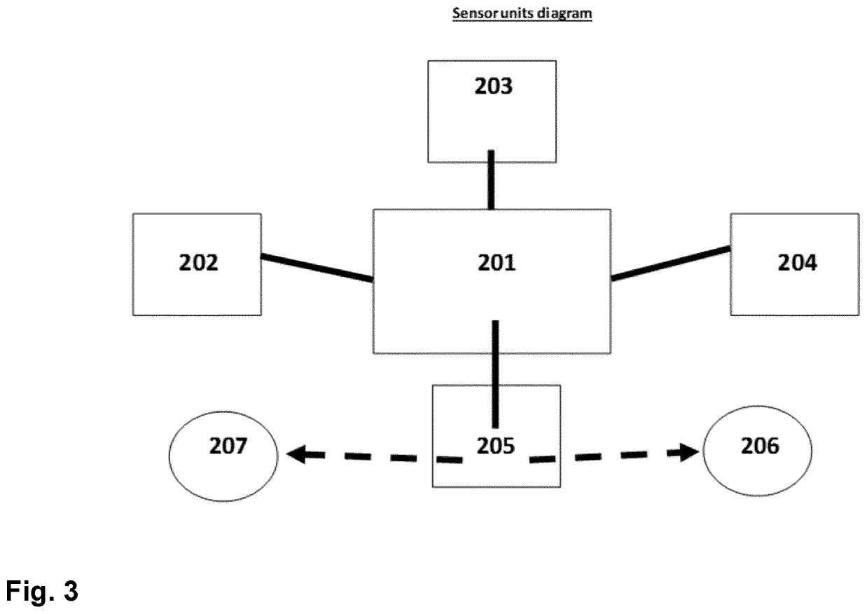

FIG. 3 shows a block diagram representation of interconnected sensor units in a MOB detection system in accordance with the principles of the present disclosure.

The drawing represents the functionality configuration of the sensor units of the Man Over Board detection system. The boxes in the drawing represent physical units, while the circles represent the integrated software. The straight lines represent physical cables, while the dashed arrow line represents to which physical unit the software is integrated upon.

An interconnector unit 201 connects the different sensors and collects data for the integrated data fusion processing unit. The different sensor units can be configured and adjusted, here they are being portrayed with a simple configuration, which includes two (or more) multibeam laser scanner units 202, two (or more) networked radar units 203, and three (or more) video camera units 204. Any of these sensor units may optionally include embedded local software for first stage object detection and situation awareness. A data fusion processing unit 205 may be configured for data fusing collected by the interconnector unit 201, and may include integrated video verification software 206. The integrated video verification software 206 may be capable of all perimeter, all angles coverage and high resolution with video due to the scanners, radars and video coverage around the periphery of the vessel. Additionally, the data fusion processing unit 205 may include integrated sensor signal processing software 207 with data fusion capabilities, MOB event detection capabilities, MOB event verification capabilities and the capability of stitching, target tracking and also self-learning AI capabilities. The data captured from each sensor unit may be recorded in its final data format. The MOB system utilizes video as means of recording of a MOB alarm and the video associated with an alarm is equal to the native resolution and frame rate of the camera. All required system data are embedded with a date and time stamp in a manner that is compliant with national and international evidential standards. The system may utilize the time code input from a valid coordinated universal time (UTC) feed to generate the date and time stamp.

What is claimed is:

1-50. (canceled)

51. A man over board (MOB) detection system, comprising:
a plurality of sensor units located around a periphery of a vessel;
an interconnector unit communicatively coupled with the plurality of sensor units and configured to receive data from the plurality of sensor units;
a data fusion processing unit configured to receive the data from the plurality of sensor units via the interconnector unit, compile the data from the plurality of sensor units, and trigger a MOB warning based on the compiled data;
a control station located at a bridge of the vessel and configured to display the MOB warning and at least a portion of the compiled data from the plurality of sensor units via a video verification interface and receive verification input from a human operator via the video verification interface to confirm a MOB event.

52. The MOB detection system of claim 51, wherein the plurality of sensor units comprises one or more of: a laser scanner or a radar alarm, and wherein the data fusion processing unit triggers the MOB warning based at least in part on the laser scanner or the radar alarm.

53. The MOB detection system of claim 52, wherein at least the portion of the compiled data from the plurality of sensor units comprises video pre-processing data that augments the MOB warning triggered by the laser scanner of the radar alarm.

54. The MOB detection system of claim 51, wherein the control station is further configured to display the MOB warning as a visual alarm that remains active until the verification input is received from the human operator.

55. The MOB detection system of claim 51, wherein the control station is further configured to sound an audible alarm in response to the MOB event, wherein the audible alarm remains active until the verification input is received from the human operator.

56. The MOB detection system of claim 51, wherein the plurality of sensor units are connected to the interconnector unit via one or more of: fiber optical cabling, ethernet cabling, wireless connectivity, or a combination thereof.

57. The MOB detection system of claim 51, wherein one or more sensor units of the plurality of sensor units are configured to execute embedded local code for first stage object detection, and wherein the MOB warning is triggered based at least in part on the first stage object detection.

58. The MOB detection system of claim 57, wherein the plurality of sensor units is distributed around the periphery of the vessel such that the plurality of sensor units is configured to detect a human within a MOB detection zone defined as a fixed distance from the periphery of the vessel.

59. The MOB detection system of claim 58, wherein the plurality of sensor units comprises a laser scanner unit configured to perform the first stage object detection by detecting an object of a specified size falling in the MOB detection zone with an acceleration equivalent to gravity.

60. The MOB detection system of claim 51, wherein the control station and the data fusion processing unit are further configured, upon receiving the verification input, to generate a message in National Marine Electronics Association (NMEA) format based at least in part on the MOB event.

61. A method of man over board (MOB) detection, comprising:
obtaining data from a plurality of sensor units located around a periphery of a vessel;
compiling the data from the plurality of sensor units at a data fusion processing unit configured;
analyzing the compiled data from the plurality of sensor units at the data fusion processing unit to trigger a MOB warning;
displaying the MOB warning and at least a portion of the compiled data at a control station located at a bridge of the vessel via a video verification interface; and
receive verification input from a human operator via the video verification interface to confirm a MOB event.

62. The method of claim 61, wherein the plurality of sensor units comprises one or more of: a laser scanner or a radar alarm, and wherein the MOB warning is triggered based at least in part on the laser scanner or the radar alarm.

63. The method of claim 62, wherein at least the portion of the compiled data from the plurality of sensor units comprises video pre-processing data that augments the MOB warning triggered by the laser scanner of the radar alarm.

64. The method of claim 61, wherein displaying the MOB warning comprises:
displaying a visual alarm that remains active until the verification input is received from the human operator.

65. The method of claim 61, further comprising:
sounding an audible alarm in response to the MOB event, wherein the audible alarm remains active until the verification input is received from the human operator.

66. The method of claim 61, wherein obtaining the data from the plurality of sensor units comprises:
receiving the data at the data fusion processing unit via an interconnector unit, wherein the data is received via one or more of: fiber optical cabling, ethernet cabling, wireless connectivity, or a combination thereof.

67. The method of claim 61, further comprising:
performing a first stage object detection at one or more sensor units of the plurality of sensor units, wherein the MOB warning is triggered based at least in part on the first stage object detection.

68. The method of claim 67, wherein the plurality of sensor units is distributed around the periphery of the vessel such that the plurality of sensor units is configured to detect a human within a MOB detection zone defined as a fixed distance from the periphery of the vessel.

69. The method of claim 68, wherein the plurality of sensor units comprises a laser scanner unit, and wherein performing the first stage object detection comprises by using the laser scanner unit to detect an object of a specified size falling in the MOB detection zone with an acceleration equivalent to gravity.

70. The method of claim 61, further comprising:
generating a message in National Marine Electronics Association (NMEA) format based at least in part on the MOB event upon receiving the verification input.
